(19) United States
(12) Patent Application Publication
(10) Pub. No.: US 2024/0376230 A1
(43) Pub. Date: Nov. 14, 2024

(54) A METHYLCELLULOSE WITH HIGH POWDER DISSOLUTION TEMPERATURE

(71) Applicant: Nutrition & Biosciences USA 1, LLC, Rochester, NY (US)

(72) Inventors: MATTHIAS KNARR, BOMLITZ (DE); ANJA A.P. PUETTMANN, BOMLITZ (DE); OLIVER PETERMANN, BOMLITZ (DE)

(21) Appl. No.: 18/554,318

(22) PCT Filed: Apr. 7, 2022
(86) PCT No.: PCT/EP2022/059256

§ 371 Date: Oct. 6, 2023

(30) Foreign Application Priority Data
Apr. 9, 2021 (EP) 21167635.8

(51) Int. Cl. C08B 11/02; C08J 3/12

(52) U.S. Cl. CPC C08B 11/02; C08J 3/12; C08J 2301/28

(57) ABSTRACT

A methylcellulose composed of anhydroglucose units joined by 1-4 linkages, wherein hydroxy groups of the anhydroglucose units are substituted with methyl groups such that the s23/s26 is 0.45 or more,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups.

### FIELD OF INVENTION

The present invention relates to a methylcellulose with a high powder dissolution temperature and a method of making such a methylcellulose.

### INTRODUCTION

Methylcellulose ethers are useful for a wide variety of purposes. Methylcellulose ethers are normally manufactured in the form of powders, and for most purposes, it is desirable to dissolve the powder in water. However, many methylcellulose ethers have powder dissolution temperature of 25° C. or below. To dissolve such methylcellulose ethers in water requires cooling equipment, which adds complexity and expense to the process of using the methylcellulose ether. It is desired to find a method to raise the powder dissolution temperature of such a methylcellulose ether and to find methylcellulose ether powders that are made by such a method.

WO 2016/196153 addresses the problem of low powder dissolution temperature of methylcelluloses, especially those that have a low gelation temperature, by a method that involves dissolving a methylcellulose in water at a low temperature (typically below 25° C.) and drying the methylcellulose out of the solution e.g. by spray drying or precipitation in hot water or an organic solvent in which the methylcellulose is not soluble. This method resulted in methylcellulose with an increased powder dissolution temperature.

It is desired to find an alternative method of producing methylcellulose ethers in a powder form that has powder dissolution temperature that is higher than previously known powders of methylcellulose ethers.

### SUMMARY OF THE INVENTION

Accordingly, the present invention relates to a methylcellulose composed of anhydroglucose units joined by 1-4 linkages, wherein hydroxy groups of the anhydroglucose units are substituted with methyl groups such that the s23/s26 is 0.45 or more,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups.

It has surprisingly been found that by providing a production process for methylcellulose where cellulose pulp is alkalized and methylated either sequentially or concurrently and where the reaction temperature during methylation is slowly increased over an extended period of time, it is possible to synthesize methylcellulose with an s23/s26 of 0.45 or more and a powder dissolution temperature that is higher than for methylcelluloses that are prepared without slowly increasing the reaction temperature.

Thus, in another aspect, the invention relates to a process for preparing a methylcellulose composed of anhydroglucose units joined by 1-4 linkages, wherein hydroxy groups of the anhydroglucose units are substituted with methyl groups such that the s23/s26 is 0.45 or more,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups,
the process comprising the steps of
   (a) treating cellulose pulp with an alkalization agent at a temperature below 55° C.,
   (b) adding a methylating agent before, after or concurrently with the alkalization agent while increasing the reaction temperature to a temperature of 60° C. or more at a heating rate of from 0.3° C. to 0.6° C. per minute and reacting the alkalized cellulose with the methylating agent for 45 minutes or less at the final reaction temperature, and
   (c) washing the methylcellulose prepared in step (b).

### BRIEF DESCRIPTION OF THE DRAWINGS

FIG. 1A and FIG. 1B are graphs showing the powder dissolution temperature of methylcelluloses prepared by the process of the invention compared to the powder dissolution temperature of methylcelluloses prepared by a process that does not involve a slow increase of the reaction temperature.

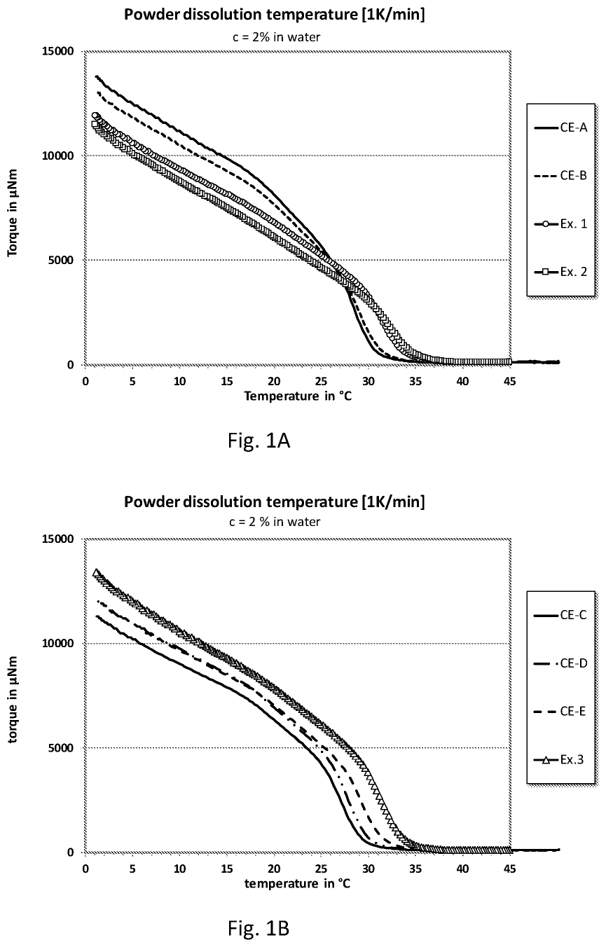

### DESCRIPTION OF EMBODIMENTS

Cellulose is a naturally occurring polysaccharide polymer composed of anhydroglucose units joined by 1-4 linkages. Each anhydroglucose unit contains hydroxyl groups at the 2, 3, and 6 positions. Partial or complete substitution of these hydroxyls creates cellulose derivatives. For example, treatment of cellulosic fibers with an alkaline solution, followed by a methylating agent, yields cellulose ethers substituted with one or more methoxy groups. If not further substituted with other alkyls, such a cellulose ether is known as methylcellulose.

An essential feature of the specific methylcellulose of the present invention is the position of the methyl groups. The composition of the invention comprises a methylcellulose wherein hydroxy groups of anhydroglucose units are substituted with methyl groups such that s23/s26 is 0.45 or more.

In the ratio s23/s26, s23 is the molar fraction of anhydroglucose units wherein only the two hydroxy groups in the 2- and 3-positions of the anhydroglucose unit are substituted with methyl groups and s26 is the molar fraction of anhydroglucose units wherein only the two hydroxy groups in the 2- and 6-positions of the anhydroglucose unit are substituted with methyl groups. For determining the s23, the term “the molar fraction of anhydroglucose units wherein only the two hydroxy groups in the 2- and 3-positions of the anhydroglucose unit are substituted with methyl groups” means that the two hydroxy groups in the 2- and 3-positions are substituted with methyl groups and the 6-positions are unsubstituted hydroxy groups. For determining the s26, the term “the molar fraction of anhydroglucose units wherein only the two hydroxy groups in the 2- and 6-positions of the anhydroglucose unit are substituted with methyl groups” means that the two hydroxy groups in the 2- and 6-positions are substituted with methyl groups and the 3-positions are unsubstituted hydroxy groups.

Formula I below illustrates the numbering of the hydroxy groups in anhydroglucose units.

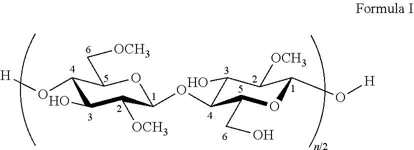

In one embodiment of the invention hydroxy groups of anhydroglucose units are substituted with methyl groups such that the s23/s26 of the methylcellulose is preferably from 0.45 to 0.70, more preferably from 0.46 to 0.60, most preferably from 0.47 to 0.55.

The methylcellulose of the present invention preferably has a content of methoxyl groups of from 26 to 33%. The determination of the methoxyl content in methylcellulose is carried out according to the United States Pharmacopeia (USP 34). The values obtained are % methoxyl.

The viscosity of the methylcellulose of the present invention is generally from 10 mPa·s to 100,000 mPa·s when measured as a 2 wt. % aqueous solution at 20° C. at a shear rate of 10 s⁻¹.

The methylcellulose of the invention is preferably in powder form.

When a solution is made of the methylcellulose powder in water, the solution shows a gelation temperature. That is, for many methylcelluloses, after the solution is made, if the temperature is then raised, the methylcellulose will remain in solution, even above the powder dissolution temperature. If the temperature is raised further, for many methylcelluloses, the solution will form a gel.

In an aqueous solution, the methylcelluloses of the present invention generally form a gel at temperatures from 50° C. to 80° C.

Methods of making methylcellulose are described in more detail in the Examples. Generally, cellulose pulp is treated with an alkalization agent, for example alkali metal hydroxide (as a 50% by weight aqueous solution). Preferably, about 3,0 to 6.0 mol NaOH per mol anhydroglucose units in the cellulose is used. Uniform swelling and alkali distribution in the pulp is optionally controlled by mixing and agitation. The rate of addition of aqueous alkaline hydroxide is governed by the ability to cool the reactor during the exothermic alkalization reaction. In one embodiment, an organic solvent such as dimethyl ether is added to the reactor as a diluent and coolant. Likewise, the headspace of the reactor is optionally purged with an inert gas (such as nitrogen) to minimize unwanted reactions with oxygen and molecular weight losses of the methylcellulose. In one embodiment, the temperature during alkalization is maintained at or below 55° C., preferably below 50° C., more preferably below 45° C., most preferably below 40° C. or even at about 30° C.

A methylating agent such as methyl chloride is also added by conventional means to the cellulose pulp either before or after or concurrently with the alkalization agent, generally in an amount of 4.0-8.0 mol methylating agent per mol anhydroglucose units in the cellulose. Preferably, the methylating agent is added after the alkalization agent. Once the cellulose has been contacted with alkalization agent and methylating agent, the reaction temperature is increased to a final reaction temperature of 60° C. or more, preferably from 65° C. to 75° C., more preferably from 70° C. to 75° C. at a heating rate of from 0.3° C. to 0.55° C. per minute, e.g. a heating rate of from 0.3° C. to 0.4° C. per minute when the final reaction temperature is 75° C. or a heating rate of from 0.3 to 0.55° C. when the final reaction temperature is 70° C. Such a slow increase of the reaction temperature has been found to be critical for the synthesis of the inventive methylcellulose with s23/s26 of 0.45 or more and a powder dissolution temperature of 32° C. or more. Once the final reaction temperature has been reached, the alkalized cellulose is reacted with the methylating agent for 40 minutes or less, preferably 30 minutes or less.

The resulting methylcellulose is washed to remove salt and other reaction by-products. Any solvent in which salt is soluble may be employed, but hot water is preferred, where the methylcellulose is not soluble. The methylcellulose may be washed in the reactor, but is preferably washed in a separate washer located downstream of the reactor. Before or after washing, the methylcellulose may be stripped by exposure to steam to reduce residual organic content. The methylcellulose may subsequently be subjected to a partial depolymerizing process. Partial depolymerizing processes are known in the art and described in e.g. EP 1141029, EP 210917, EP 1423433 and U.S. Pat. No. 4,316,982. Alternatively, partial depolymerization can be achieved during the production of the methylcellulose, for example by the presence of oxygen or an oxidizing agent.

The methylcellulose is preferably dried to a reduced moisture content of 1 to 10.0% by weight of water and more preferably 2 to 5.0% by weight of water and volatiles based on the weight of methylcellulose. The dried methylcellulose may generally be milled into particles and sieved through a sieve with about 500 μm openings. If desired, drying and milling may be carried out simultaneously.

When water is mixed with methylcellulose in powder form at a temperature above the powder dissolution temperature (PDT), the methylcellulose will not be dissolved. Conversely, when the mixture is below the PDT, the methylcellulose will dissolve in the water. Methylcelluloses in general suffer from the drawback that their PDT is rather low (below 30° C., in particular below 25° C.) and they require cooling when used for the preparation of food products. While this is not an issue with meat-based food products such as sausages which are generally prepared at low temperatures, other food products such as plant-based meat alternatives do not require low processing temperatures, and the manufacturers may prefer to avoid low temperatures to save energy costs. The methylcellulose of the present invention has unexpectedly been found to have a PDT that is higher than the PDT of commercial methylcelluloses. The PDT of the methylcellulose of the invention has been found to be 32° C. or more, preferably from 33° C. to 45° C., more preferably 34° C. to 40° C., when determined as a 2% aqueous sample suspended in high temperature water, where the MC is not soluble at the beginning of the measurement. The methylcellulose of the invention offers the option of hydration without cooling due to the increased PDT and makes them particularly suitable for the preparation of plant-based food products such as meat alternatives. Also, since the present methylcellulose does not require low temperatures to dissolve in water, its use for other applications may be an advantage as it involves energy savings. For example, the present methylcellulose may also be used as an additive in other food products to provide desirable physical properties such as thickening, freeze/thaw stability, moisture retention and release, film formation, texture, consistency, emulsification, binding and suspension. The present methylcellulose may additionally be useful as a component in industrial products, construction materials, agricultural products, personal care products, household care products as well as an excipient in pharmaceutical formulations, e.g. as a component of capsules or tablet coatings.

The PDT is determined as follows. Measurements may be made, for example, with a Haake RS1 rheometer.

A Cup (Couette) Z-34 geometry with a wing stirrer (the diameter and the height of the stirrer plate are 30 mm each; the wing plate has 4 perforations of 5 mm diameter). The amounts of water and cellulose ether are chosen to achieve a final concentration of 2%. 58.8 g of water is added into the cup and heated up to 50° C. At this temperature 1.2 g of the cellulose ether is slowly added. At this temperature the cellulose ether is insoluble and the suspension is stirred with 500 rpm for 60 sec. After a good suspension is achieved the temperature is decreased at a fixed cooling rate of 1° C./min, while stirring with 300 rpm. The torque is recorded with 4 data points/min. starting at 50° C. and ending at a temperature at least 1° C. lower than the estimated onset dissolution temperature, resulting in a torque build-up curve as function of temperature. For the further analysis of the onset dissolution temperature the data are normalized according to the following equation:

$${M}_{n o r m} = \frac{M - {M}_{i}}{{M}_{max} - {M}_{i}}$$

where M represents the measured torque at a specific temperature, Mᵢ represents the start value of torque at the highest temperature (e.g., at 50° C.) at 300 rpm and Mₘₐₓ represents the final torque at the lowest temperature (e.g., at 1° C.). For analysis of the onset dissolution temperature the values of torque (y-axis) are plotted against the temperature (x-axis).

Linear regressions are performed to the obtained torque values for multiple temperature increments, each increment covering 2.5° C. An increment is started every 0.1° C. The linear regression with the largest slope is determined, and the point of intersection of that linear regression with the temperature axis is the PDT.

Some embodiments of the invention will now be described in detail in the following Examples.

Unless otherwise mentioned, all parts and percentages are by weight. In the Examples the following test procedures are used.

Determination of s23/s26 of Methylcellulose

The approach to measure the ether substituents in methylcellulose is generally known. See for example the approach described in principle for Ethyl Hydroxyethyl Cellulose in Carbohydrate Research, 176 (1988) 137-144, Elsevier Science Publishers B. V., Amsterdam, DISTRIBUTION OF SUBSTITUENTS IN O-ETHYL-O-(2-HYDROXYETHYL) CELLULOSE by Bengt Lindberg, Ulf Lindquist, and Olle Stenberg.

Specifically, determination of s23/s26 was conducted as follows: 10-12 mg of the methylcellulose were dissolved in 4.0 mL of dry analytical-grade dimethyl sulfoxide (DMSO) (Merck, Darmstadt, Germany, stored over 0.3 nm molecular sieve beads) at about 90° C. with stirring and then cooled to room temperature. The solution was stirred at room temperature over night to ensure complete solubilization/dissolution. The entire perethylation including the solubilization of the methylcellulose was performed using a dry nitrogen atmosphere in a 4 mL screw cap vial. After solubilization, the dissolved methylcellulose was transferred to a 22-mL screw-cap vial to begin the perethylation process. Powdered sodium hydroxide (freshly pestled, analytical grade, Merck, Darmstadt, Germany) and ethyl iodide (for synthesis, stabilized with silver, Merck-Schuchardt, Hohenbrunn, Germany) were introduced in a thirty-fold molar excess relative to the level of anhydroglucose units in the methylcellulose, and the mixture was vigorously stirred under nitrogen in the dark for three days at ambient temperature. The perethylation was repeated with addition of the threefold amount of the reagents sodium hydroxide and ethyl iodide compared to the first reagent addition, and stirring at room temperature was continued for an additional two days. Optionally, the reaction mixture could be diluted with up to 1.5 mL DMSO to ensure good mixing during the course of the reaction. Next, five mL of 5% aqueous sodium thiosulfate solution was poured into the reaction mixture, and the mixture was then extracted three times with 4 mL of dichloromethane. The combined extracts were washed three times with 2 mL of water. The organic phase was dried with anhydrous sodium sulfate (about1 g). After filtration, the solvent was removed with a gentle stream of nitrogen, and the sample was stored at 4° C. until needed.

Hydrolysis of about 5 mg of the perethylated samples was performed under nitrogen in a 2-mL screw-cap vial with 1 mL of 90% aqueous formic acid under stirring at 100° C. for 1 hour. The acid was removed in a stream of nitrogen at 35-40° C. and the hydrolysis was repeated with 1 mL of 2M aqueous trifluoroacetic acid for 3 hours at 120° C. in an inert nitrogen atmosphere with stirring. After completion, the acid was removed to dryness in a stream of nitrogen at ambient temperature using ca. 1 mL of toluene for co-distillation.

The residues of the hydrolysis were reduced with 0.5 mL of 0.5-M sodium borodeuteride in 2N aqueous ammonia solution (freshly prepared) for 3 hours at room temperature with stirring. The excess reagent was destroyed by dropwise addition of about 200 μL of concentrated acetic acid. The resulting solution is evaporated to dryness in a stream of nitrogen at about 35-40° C. and subsequently dried in vacuum for 15 min at room temperature. The viscous residue was dissolved in 0.5 mL of 15% acetic acid in methanol and evaporated to dryness at room temperature. This was done five times and repeated four additional times with pure methanol. After the final evaporation, the sample was dried in vacuum overnight at room temperature.

The residue of the reduction was acetylated with 600 μL of acetic anhydride and 150 μL of pyridine for 3 hrs at 90° C. After cooling, the sample vial was filled with toluene and evaporated to dryness in a stream of nitrogen at room temperature. The residue was dissolved in 4 mL of dichloromethane and poured into 2 mL of water and extracted with 2 mL of dichloromethane. The extraction was repeated three times. The combined extracts were washed three times with 4 mL of water and dried with anhydrous sodium sulfate. The dried dichloromethane extract was subsequently submitted to GC analysis. Depending on the sensitivity of the GC system, a further dilution of the extract could be necessary.

Gas-liquid (GLC) chromatographic analyses were performed with Agilent 6890N type of gas chromatographs (Agilent Technologies GmbH, 71034 Boeblingen, Germany) equipped with Agilent J&W capillary columns (30 m, 0.25-mm ID, 0.25-μm phase layer thickness) operated with 1.5-bar helium carrier gas. The gas chromatograph was programmed with a temperature profile that held constant at 60° C. for 1 min, heated up at a rate of 20° C./min to 200° C., heated further up with a rate of 4° C./min to 250° C., and heated further up with a rate of 20° C./min to 310° C. where it was held constant for another 10 min. The injector temperature was set to 280° C. and the temperature of the flame ionization detector (FID) was set to 300° C. Exactly 1 μL of each sample was injected in the splitless mode at 0.5-min valve time. Data were acquired and processed with a LabSystems Atlas work station.

Quantitative monomer composition data were obtained from the peak areas measured by GLC with FID detection. Molar responses of the monomers were calculated in line with the effective carbon number (ECN) concept but modified as described in the table below. The effective carbon number (ECN) concept has been described by Ackman (R. G. Ackman, J. Gas Chromatogr., 2 (1964) 173-179 and R. F. Addison, R. G. Ackman, J. Gas Chromatogr., 6 (1968) 135-138) and applied to the quantitative analysis of partially alkylated alditol acetates by Sweet et. Al (D. P. Sweet, R. H. Shapiro, P. Albersheim, Carbohyd. Res., 40 (1975) 217-225).

### ECN Increments Used for ECN Calculations:

| Type of carbon atom | ECN increment |
|---|---|
| hydrocarbon | 100 |
| primary alcohol | 55 |
| secondary alcohol | 45 |

In order to correct for the different molar responses of the monomers, the peak areas were multiplied by molar response factors MRFmonomer which are defined as the response relative to the 2,3,6-Me monomer. The 2,3,6-Me monomer were chosen as reference since it was present in all samples analyzed in the determination of s23/s26.

MRFmonomer=ECN2,3,6-Me/ECNmonomer

The mol fractions of the monomers were calculated by dividing the corrected peak areas by the total corrected peak area according to the following formulas:
(1) s23 is the sum of the molar fractions of anhydroglucose units which meet the following condition [the two hydroxy groups in the 2- and 3-positions of the anhydroglucose unit are substituted with methyl groups, and the 6-position is not substituted (=23-Me)]; and
(2) s26 is the sum of the molar fractions of anhydroglucose units which meet the following condition [the two hydroxy groups in the 2- and 6-positions of the anhydroglucose unit are substituted with methyl groups, and the 3-position is not substituted (=26-Me)].

### Determination of the Methoxyl Content of a Methylcellulose

The determination of the % methoxyl in methylcellulose was carried out according to the United States Pharmacopeia (USP34). The values obtained were % methoxyl.

### Production of a 2% Pure Aqueous Solution of the Methylcellulose

To obtain a 2% aqueous solution of methylcellulose, 3 g of milled, ground, and dried methylcellulose (under consideration of the water content of the methylcellulose) were added to 147 g of tap water (temperature 20-25° C.) at room temperature while stirring with an overhead lab stirrer at 750 rpm with 3-wing (wing=2 cm) blade stirrer. The solution was cooled with ice for 1 h in order to achieve complete hydration of the powder. Afterwards the solutions was stored in the refrigerator overnight.

### Determination of the Viscosity of Methylcellulose

The steady-shear-flow viscosity n (20° C., 10 s⁻¹, 2 wt. % MC) of an aqueous 2-wt. % methylcellulose solution was measured at 20° C. with a Physica MCR 501 rheometer with cone & plate geometry (CP50-1/TG) over a shear rate regime from 0.1-1000 s⁻¹ with 21 data points. Based on this data the viscosity at 10 s⁻¹ was assesed to describe these materials.

### EXAMPLES

### Production of Methylcellulose

Methylcellulose was produced according to the following procedure. Finely ground wood cellulose pulp was loaded into a jacketed, agitated reactor. The reactor was evacuated and purged with nitrogen to remove oxygen, and then evacuated again. The reaction is carried out in two stages. In the first stage, a 50% by weight aqueous solution of sodium hydroxide was sprayed onto the cellulose until the level reached 4.75 mol of sodium hydroxide per mol of anhydroglucose units of the cellulose, this has been performed at a constant temperature of 30° C. After stirring the mixture of aqueous sodium hydroxide solution and cellulose for about 30 minutes at 30° C., 1.2 mol of dimethyl ether and 5.7 mol of methyl chloride per mol of anhydroglucose units were added to the reactor. The contents of the reactor were then heated as shown in Tables 1 and 2, respectively. After reaching the desired reaction temperature, the reaction was allowed to proceed as shown in Tables 1 and 2. At the end of the reaction the pressure was released and the reactor was purged with nitrogen for two time. Afterwards the temperature was decreased to ambient temperature

The contents of the reactor were removed and transferred to a tank containing hot water. The crude methylcellulose was then neutralized with formic acid and washed chloride free with hot water (assessed by AgNO₃ flocculation test), cooled to room temperature and dried at 55° C. in an air-swept drier, and the material is then ground using e.g. an Alpine UPZ mill using a 0.5-mm screen.

TABLE 1

| | CE-A | CE-B | Ex. 1 | Ex. 2 |
|---|---|---|---|---|
| Alkalization temp. (° C.) | 30 | 30 | 30 | 30 |
| NaOH 1 mol/mol (50% solution) | 4.75 | 4.75 | 4.75 | 4.75 |
| Alkalization time (min) | 30 | 30 | 30 | 30 |
| DME (mol/mol) | 1.20 | 1.20 | 1.20 | 1.20 |
| MCI - addition (mol/mol) | 5.70 | 5.70 | 5.70 | 5.70 |
| Heating rate (° C./min) | 1.33 | 0.80 | 0.53 | 0.40 |
| Time to reach reaction temp. | 30 | 50 | 75 | 100 |
| Reaction temp. (° C.) | 70 | 70 | 70 | 70 |
| Reaction time (min) | 70 | 50 | 30 | 15 |

TABLE 2

| | CE-C | CE-D | CE-E | Ex. 3 |
|---|---|---|---|---|
| Alkalization temp. (° C.) | 30 | 30 | 30 | 30 |
| NaOH 1 mol/mol (50% solution) | 4.75 | 4.75 | 4.75 | 4.75 |
| Alkalization time (min) | 30 | 30 | 30 | 30 |
| DME (mol/mol) | 1.20 | 1.20 | 1.20 | 1.20 |
| MCI - addition (mol/mol) | 5.70 | 5.70 | 5.70 | 5.70 |
| Heating rate (° C./ min) | 1.5 | 0.75 | 0.5 | 0.375 |
| Time to reach reaction temp. | 30 | 60 | 90 | 120 |
| Reaction temp. (° C.) | 75 | 75 | 75 | 75 |
| Reaction time (min) | 60 | 40 | 20 | 10 |

The properties of the methylcelluloses were determined as described above. The results are shown in Table 3 below.

TABLE 3

| | CE-A | CE-B | Ex. 1 | Ex. 2 | CE-C | CE-D | CE-E | Ex. 3 |
|---|---|---|---|---|---|---|---|---|
| Onset PDT | 30.7 | 31.4 | 34.0 | 35.0 | 29.5 | 30.2 | 31.7 | 33.9 |
| FC - viscosity @ | 6900 | 7230 | 6920 | 5840 | 6650 | 6710 | 6750 | 6170 |
| 2.55 s−1 [mPas] | | | | | | | | |
| FC - viscosity @ | 4470 | 4730 | 4510 | 4050 | 4330 | 4460 | 4450 | 4290 |
| 10 s−1 [mPas] | | | | | | | | |
| S23/s26 | N.A. | N.A. | 0.49 | 0.50 | N.A. | N.A. | N.A. | 0.48 |

It appears from Table 3 that methylcelluloses of the invention (Examples 1-3) have an increased PDT (above 32° C.) compared to the methylcelluloses prepared without slowly increasing the reaction temperature (Comparative Examples A-E).

1. A methylcellulose composed of anhydroglucose units joined by 1-4 linkages, wherein hydroxy groups of the anhydroglucose units are substituted with methyl groups such that the s23/s26 is 0.45 or more,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups.

2. The methylcellulose of claim 1, wherein the s23/s26 is from 0.46 to 0.60.

3. The methylcellulose of claim 1, wherein the s23/s26 is from 0.47 to 0.55.

4. The methylcellulose of claim 1, which is in powder form.

5. The methylcellulose of claim 1, which has a powder dissolution temperature of 32° C. or more in aqueous solution.

6. The methylcellulose of claim 5 which has a powder dissolution temperature from 33° C. to 45° C. in aqueous solution.

7. The methylcellulose of claim 5 which has a powder dissolution temperature from 34° C. to 40° C. in aqueous solution.

8. A process for preparing a methylcellulose composed of anhydroglucose units joined by 1-4 linkages, wherein hydroxy groups of the anhydroglucose units are substituted with methyl groups such that the s23/s26 is 0.45 or less,
wherein s23 is the molar fraction of anhydroglucose units wherein only the two hydroxy groups in the 2- and 3-positions of the anhydroglucose unit are substituted with methyl groups and
wherein s26 is the molar fraction of anhydroglucose units wherein only the two hydroxy groups in the 2- and 6-positions of the anhydroglucose unit are substituted with methyl groups,
the process comprising the steps of
(a) treating cellulose pulp with an alkalization agent at a temperature below 55° C.,
(b) adding a methylating agent before, after or concurrently with the alkalization agent while increasing the reaction temperature to a temperature of 60° C. or more at a heating rate of from 0.3° C. to 0.6° C. per minute and reacting the alkalized cellulose with the methylating agent for 45 minutes or less at the final reaction temperature and
(c) washing the methylcellulose prepared in step (b).

9. The process of claim 8, wherein the methylcellulose of step (c) is dried and milled to a powder.

10. The process of claim 8, wherein step (a) is carried out at a temperature of 50° C. or less.

11. The process of claim 8, wherein the reaction temperature in step (b) is increased to a temperature of from 65° C. to 70° C.

12. The process of claim 8, wherein the reaction temperature in step (b) is increased at a heating rate of from 0.3° C. per minute to 0.4° C. per minute to a temperature of 75° C.

13. The process of claim 8, wherein the reaction temperature in step (b) is increased at a heating rate of from 0.3° C. per minute to 0.55° C. per minute to a temperature of 70° C.

14. The process of claim 8, wherein the alkalized cellulose is reacted with the methylating agent in step (b) for 40 minutes or less at the final reaction temperature.
